(19) United States
(12) Patent Application Publication
(10) Pub. No.: US 2009/0077843 A1
(43) Pub. Date: Mar. 26, 2009

(54) LICENSE PLATE FRAME WITH ILLUMINATED SCULPTURE

(76) Inventors: Maurice S. Dayan, Oakhurst, NJ (US); Mervin A. Dayan, Oakhurst, NJ (US)

Correspondence Address: BUCHANAN, INGERSOLL & ROONEY PC, POST OFFICE BOX 1404, ALEXANDRIA, VA, 22313-1404, US

(21) Appl. No.: 11/956,599

(22) Filed: Dec. 14, 2007

Related U.S. Application Data
(63) Continuation-in-part of application No. 29/295,287, filed on Sep. 25, 2007, now Pat. No. D562204.

(51) Int. Cl. G09F 7/18; G09F 19/00

(52) U.S. Cl. 40/209

(57) ABSTRACT

A license plate frame comprising: a frame surrounding an opening for displaying a vehicle's license plate, the frame comprising a three-dimensional decorative sculpture; and a luminary source located within the frame so as to illuminate the three-dimensional decorative sculpture. In another aspect, the invention can be a license plate decoration comprising: a horizontal member comprising a three-dimensional decorative sculpture and constructed of a colored substantially transparent material; a luminary source located within the horizontal member frame so as to illuminate the three-dimensional decorative sculpture; and first and second holes located in the horizontal member, the first and second holes sized and spaced from one another so as to facilitate mounting to a vehicle using the vehicle's license plate mounting holes.

### CROSS-REFERENCE TO RELATED APPLICATIONS

The present application is a continuation-in-part of U.S. Design Pat. No. Application 29/295,287, filed Sep. 25, 2007, now allowed, the entirety of which is hereby incorporated by reference.

### FIELD OF THE INVENTION

The present invention relates generally to license plate frames and, specifically to license plate frames having illumination capabilities.

### BACKGROUND OF THE INVENTION

License plate frames or holders are available in a wide variety of designs made from a wide variety of materials. For example, protective frames are available in which a transparent cover protects the license plate from dirt, grease, and other contaminants while yet permitting the license plate number to be viewed. Such frames generally employ a metal or rigid plastic frame. Existing license plate holders include those made of a single component overlying or wrapping around the edges of the license plate and multi-component structures having back and front portions which completely encapsulate the license plate. Of course, as the structure becomes increasingly complex, cost and difficulty of installation also generally increase.

Along with vanity license plates, decorative license plate frames or holders are popular amongst car enthusiasts as well as those wishing to make a statement or to have a decorative element on their vehicle. Because of the nature of the product, however, consumers are generally willing to spend only a nominal amount. Currently, there are available a number of decorative license plate frames on which stock and/or customized lettering and designs may be placed. For example, rigid or semi-rigid plastic strips having engraved lettering may be adhered onto the face surface of a metal license plate frame. Alternatively, lettering may be engraved into a sufficiently rigid license plate frame. Stamped metal license plate frames having one or more epoxy color coatings are also available. Each of these existing types of license plate frames, however, have limited decorative flexibility with the engraved and/or stamped designs being fairly simple and having one or few colors for manufacturing ease as well as reasonable cost of production. Moreover, existing license plate frames are either not able to be illuminated or can do so only in a basic fashion.

Thus, there remains a need therefore for an economical license plate frame having improved illumination and/or decorative characteristics that are more appealing to consumers.

### SUMMARY OF THE INVENTION

These and other needs are satisfied by the present invention, which in one aspect can be a license plate frame comprising: a frame surrounding an opening for displaying a vehicle's license plate, the frame comprising a three-dimensional decorative sculpture; and a luminary source located within the frame so as to illuminate the three-dimensional decorative sculpture.

In another aspect, the invention can be a license plate decoration comprising: a horizontal member comprising a three-dimensional decorative sculpture and constructed of a colored substantially transparent material; a luminary source located within the horizontal member frame so as to illuminate the three-dimensional decorative sculpture; and first and second holes located in the horizontal member, the first and second holes sized and spaced from one another so as to facilitate mounting to a vehicle using the vehicle's license plate mounting holes.

In yet another aspect, the invention can be a license plate frame comprising: a frame surrounding an opening for displaying a vehicle's license plate, the frame comprising a molded three-dimensional flame sculpture; a plurality of LEDs located within the frame; and the three-dimensional flame sculpture constructed of a red substantially transparent material so that when the plurality of LEDs are illuminated, the three-dimensional flame sculpture is illuminated.

### BRIEF DESCRIPTION OF THE DRAWINGS

FIG. 1 is a top perspective view of a license plate frame according to one embodiment of the present invention.

FIG. 2 is a front view of the license plate frame of FIG. 1.

FIG. 3 is a rear view of the license plate frame of FIG. 1.

FIG. 4 is a top view of the license plate frame of FIG. 1.

FIG. 5 is a bottom view of the license plate frame of FIG. 1.

FIG. 6 is a left-side view of the license plate frame of FIG. 1.

FIG. 7 is a right-side view of the license plate frame of FIG. 1.

FIG. 8 is a cross-sectional view of the license plate frame of FIG. 1 along line VIII-VIII of FIG. 2.

### DETAILED DESCRIPTION OF THE DRAWINGS

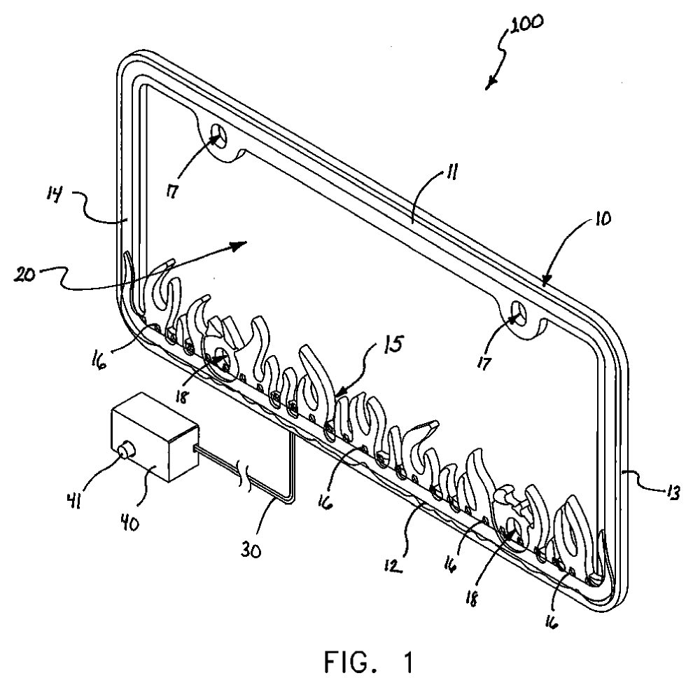

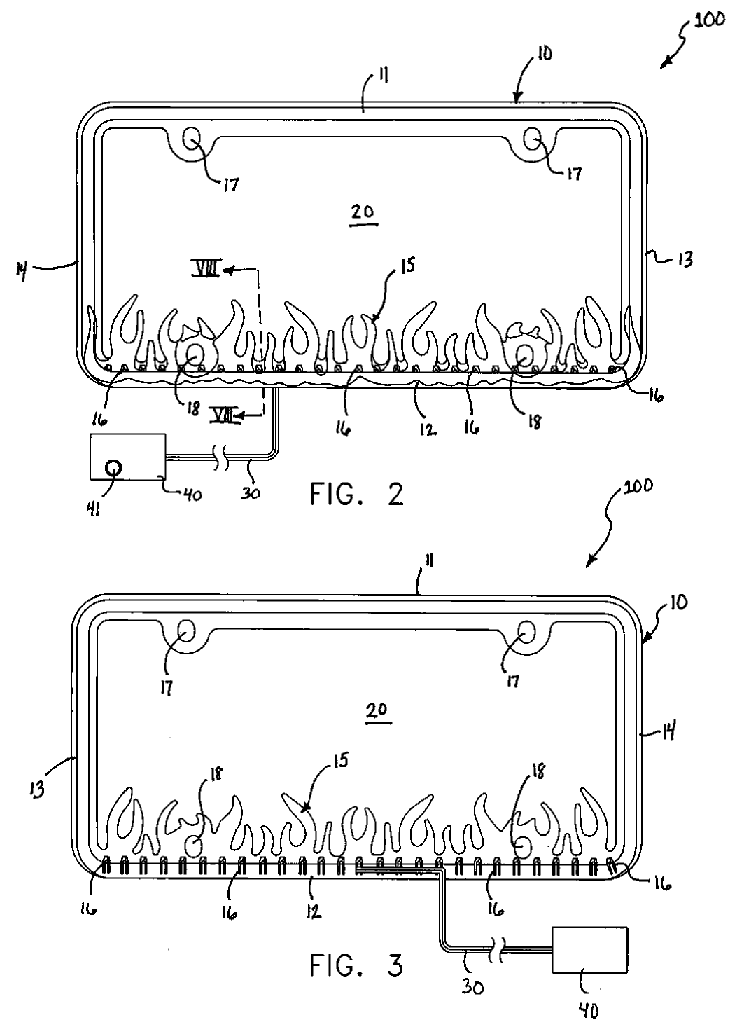

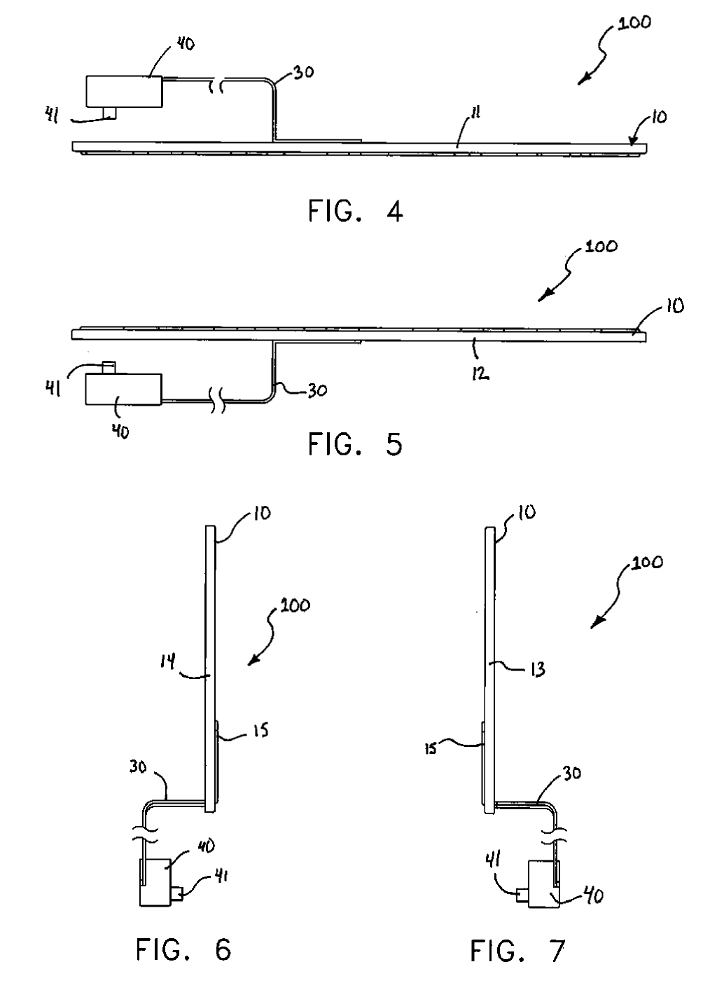

Referring first to FIGS. 1-8 concurrently, a license plate frame 100 according to one embodiment of the present invention is illustrated. The license plate frame 100 generally comprises a frame structure 10 that forms a perimeter about an opening 20. The opening 20 is preferably sized and shaped so that a vehicles license plate can be displayed therethrough. In one embodiment, the opening 20 has a height of between 4-6 inches and a length between 9-12 inches for automobile license plates in the United States. Of course, the invention is not limited to an particular size for the opening 20 and those skilled in the art will understand that the size and shape of the opening can be modified as desired.

The frame structure 10 comprises a top horizontal member 11, a bottom horizontal member 12 and vertical side members 13, 14. The ends of the horizontal members 11-12 are connected by the vertical side members 13-14 so as to form a generally rectangular structure about the opening 20. The invention however is not so limited and other shapes can be formed by the frame structure 10.

The frame structure 10 also comprises a three-dimensional decorative sculpture 15, which in the illustrated embodiment is in the form of a flame design. In the illustrated embodiment, the three-dimensional flame sculpture 15 is integrated into the bottom horizontal member 12. Of course, the three dimension decorative sculpture 15 can be located anywhere on the frame structure 10 and can extend outward, inward, or across more than one of the members 11-14. Moreover, the three-dimensional decorative sculpture 15 is not limited to a flame design but can take the form of any desired design, including without limitation animals, logos, symbols, flowers, trees, and any other design imaginable.

A row of LEDS 16 are located within the frame structure 10. The plurality of LEDs 16 are located within the three-dimensional decorative sculpture 15 portion of the frame structure 10 so that they can illuminate the flame design sculpture 15 from the interior when turned on. The LEDs 16 may also be located around the entire perimeter of the frame structure 10 if desired. As will be described in greater detail below, the LEDs 16 are visible in FIGS. 1-3 because the frame structure is preferably constructed of a colored substantially transparent material. Other luminary sources can be used instead of LEDs, including without limitation standard bulbs, etc.

The top horizontal member 11 comprises a pair of holes 17 for facilitating attachment to a vehicle. The holes 17 are preferably sized and spaced from one another so as to facilitate attachment to a vehicle using the vehicle's existing license plate mounting holes. In one embodiment, the distance between the holes 17 is between 6-8 inches, and more preferably about 7 inches.

Similarly, the bottom horizontal member 12 comprises a pair of holes 18 for facilitating attachment to a vehicle. The holes 18 are preferably sized and spaced from one another so as to facilitate attachment to a vehicle using the vehicle's existing license plate mounting holes. In one embodiment, the distance between the holes 18 is between 6-8 inches, and more preferably about 7 inches. It should also be noted that the holes 18 are built into to the three-dimensional flame sculpture 15 in manner that does not substantially distort the intended flame design.

The license plate frame 100 further comprises power supply wires 30 that extend from the interior of the frame structure 10. A first end of the power supply wires 30 is operably connected to the circuit board on which the LEDs 16 are located while a second end of the power supply wires 30 are operably connected to a battery box 40 which comprises an on/off button 41. In an alternate embodiment, the second end of the power supply wires 30 may be exposed for attachment to a circuit of the vehicle to which the license plate frame 100 will be mounted, such as the brake light circuit, the tail-light circuit or the reverse light circuit.

The battery box 40 may also comprise a control circuit for controlling the illumination patterns of the LEDs 16 if desired. For example, the control circuit may be adapted to turn the LEDs off and on in alternating fashion or to dim and brighten the LEDs in a random, set or repeating fashion to mimic a natural flame.

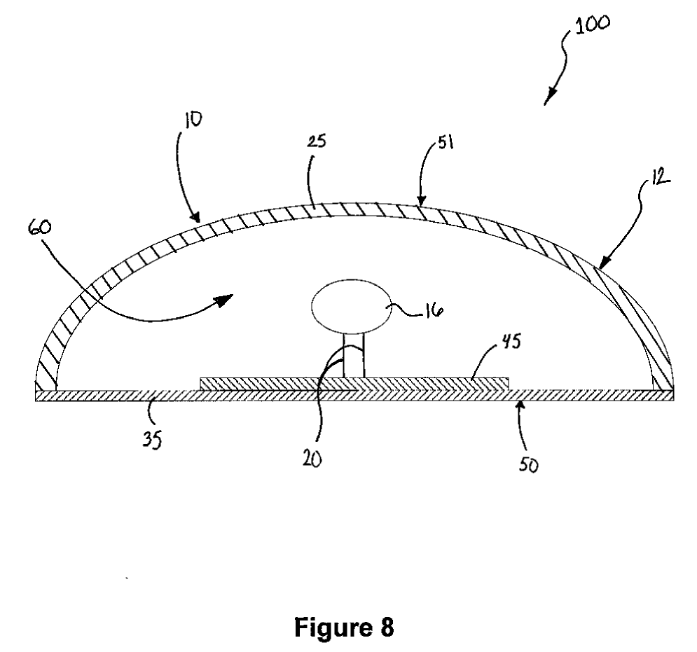

Referring solely now to FIG. 8, certain details of the license plate frame 100 will be discussed. The frame structure 10 of the license plate frame 100 generally comprises a front surface 51 and a rear surface 52. The frame structure 10 is a two-piece assembly comprising a cover piece 25 and a back plate 35. The back plate 35 is connected to a rear of the cover piece 25 so as to form a fluid-tight interior space 60, which accommodates the LEDs 16, the leads/electrodes 20, and the LED circuit board 45. Preferably, the cover piece 25 has the three-dimensional decorative sculpture 15 integrally formed therein. This can be achieved by creating the frame structure 10 out of silicon-based glue and utilizing a blister coating process. Alternatively, the frame structure 10 can be created out of plastic using a molding process, such as injection molding. The back plate 35 can be connected to the cover piece 25 by any means, including without limitation adhesives (such as silicon glue), thermal welding, etc. In another embodiment, the frame structure 10 can be formed from a solid and/or single piece of material.

The cover piece 10 (including the three-dimensional decorative sculpture 15) is preferably formed of a colored substantially transparent material or a colored translucent material. Most preferably, a silicon glue mixed with a colored powder is used create the cover piece 25 and the back plate 35. Alternatively, a flexible plastic can be used. A red substantially transparent plastic is preferred when the three-dimensional decorative sculpture 15 is a flame. Thus, in this embodiment, the create the cover piece 25 will be formed of a silicon glue mixed with a red powder that is then subjected to a blister casting process. Alternatively, the cover piece 25 can be constructed of a translucent material so long as the light from the LEDs 15 can pass therethrough and illuminate the three-dimensional decorative sculpture 15.

The back plate 35 can be constructed of the same material as the cover piece 25 or it can be constructed of a different material. It is not important that light be able to transmit through the back plate 35 because this is against the vehicle when mounted and not visible.

In other embodiments, a substantially transparent and clear material may be used for the cover piece 25. In such an embodiment, a colored film or coating may be applied to the cover piece 25 to achieve the desired color.

While the invention has been described and illustrated in detail, various alternatives and modifications will become readily apparent to those skilled in the art without departing from the spirit and scope of the invention. Specifically, the invention can take on a wide variety of embodiments that omit one or more of the components illustrated above.

What is claimed is:

1. A license plate frame comprising:
a frame surrounding an opening for displaying a vehicle's license plate, the frame comprising a three-dimensional decorative sculpture; and
a luminary source located within the frame so as to illuminate the three-dimensional decorative sculpture.

2. The license plate frame of claim 1 wherein the frame comprises a front surface and a rear surface, the luminary source located between the front and rear face of the frame.

3. The license plate frame of claim 1 wherein the frame comprises a first horizontal member and a second horizontal member, and wherein the three-dimensional decorative sculpture is formed into the first horizontal member.

4. The license plate frame of claim 3 further comprising first and second holes located in the second horizontal member, the first and second holes spaced from one another so as to facilitate mounting to a vehicle using the vehicle's license plate mounting holes.

5. The license plate frame of claim 3 further comprising first and second holes located in the three-dimensional decorative sculpture, the first and second holes spaced from one another so as to facilitate mounting to a vehicle using the vehicle's license plate mounting holes.

6. The license plate frame of claim 1 wherein the frame and the three-dimensional decorative sculpture are integrally formed from a colored substantially transparent material.

7. The license plate frame of claim 1 wherein the three-dimensional decorative sculpture is formed of a colored translucent material or a colored substantially transparent material.

8. The license plate frame of claim 7 wherein the three-dimensional decorative sculpture is formed of a red substantially transparent material and the three-dimensional decorative sculpture is a flame design.

9. The license plate frame of claim 1 wherein the luminary source comprises a plurality of LEDs arranged in a row behind the three-dimensional decorative sculpture.

10. The license plate frame of claim 1 wherein the frame comprises a cover piece and a backing piece, the backing piece connected to a rear of the cover piece so as to form a fluid-tight interior space, the luminary source located within the interior space.

11. The license plate frame of claim 10 wherein the cover piece comprises the three-dimensional decorative sculpture and is an integral single piece constructed of a colored translucent material or a colored substantially transparent material.

12. The license plate frame of claim 1 further comprising:
power wires having a first end operably connected to the luminary source and a second end for operably connection to a source of power.

13. The license plate frame of claim 12 further comprising:
the frame comprising a cover piece and a back plate, the back plate connected to a rear of the cover piece so as to form a fluid-tight interior space, the luminary source located within the interior space;
the cover piece comprising the three-dimensional decorative sculpture and being an integral single piece of flexible material;
the frame comprises a first horizontal member and a second horizontal member, the three-dimensional decorative sculpture formed into the first horizontal member;
first and second holes located in the second horizontal member, the first and second holes spaced from one another so as to facilitate mounting to a vehicle using the vehicle's license plate mounting holes;
third and fourth holes located in the three-dimensional decorative sculpture, the third and fourth holes spaced from one another so as to facilitate mounting to a vehicle using the vehicle's license plate mounting holes;
the three-dimensional decorative sculpture being a flame design; and
the luminary source comprising a plurality of LEDs arranged in a row.

14. A license plate decoration comprising:
a horizontal member comprising a three dimensional decorative sculpture and constructed of a colored substantially transparent material;
a luminary source located within the horizontal member frame so as to illuminate the three-dimensional decorative sculpture; and
first and second holes located in the horizontal member, the first and second holes sized and spaced from one another so as to facilitate mounting to a vehicle using the vehicle's license plate mounting holes.

15. A license plate frame comprising:
a frame surrounding an opening for displaying a vehicle's license plate, the frame comprising a three-dimensional flame sculpture;
a plurality of LEDs located within the frame; and
the three-dimensional flame sculpture constructed of a red substantially transparent material so that when the plurality of LEDs are illuminated, the three-dimensional flame sculpture is illuminated.
